(19) United States
(12) Patent Application Publication
(10) Pub. No.: US 2016/0150903 A1
(43) Pub. Date: Jun. 2, 2016

(54) FRAME FOR AN ORNAMENTAL DECORATION

(71) Applicant: Frederick Loos, St. Clair Shores, MI (US)

(72) Inventor: Frederick Loos, St. Clair Shores, MI (US)

(21) Appl. No.: 14/705,428

(22) Filed: May 6, 2015

Related U.S. Application Data
(60) Provisional application No. 61/994,489, filed on May 16, 2014.

(51) Int. Cl. A47G 33/00; F21S 4/00; F21V 33/00; A47G 33/06

(52) U.S. Cl. CPC A47G 33/00; A47G 33/06; F21S 4/002; F21V 33/0028; F21W 2121/04

(57) ABSTRACT

An apparatus comprising a plurality of legs. Each of the legs may have a plurality of holders and a base. The base may comprise (i) a first connector on one side of the base and (ii) a second connector on another side of the base. Each of the plurality of legs may be configured to (i) connect to the second connector of one of the plurality of legs using the first connector, (ii) connect to the first connector of another of the plurality of legs using the second connector, (iii) be flexible about an axis and (iv) be arranged in a circular fashion. The holders may be configured to secure one or more lights of a strand of lights.

This application relates to U.S. Provisional Application No. 61/994,489, filed May 16, 2014, which is hereby incorporated by reference in its entirety.

### FIELD OF THE INVENTION

The present invention relates to frames generally and, more particularly, to a method and/or apparatus for implementing a frame for an ornamental decoration.

### BACKGROUND OF THE INVENTION

Ornamental decorations are desirable, especially around the holiday season. Such decorations are intended to lighten up the mood and create a holiday spirit. While many families assemble a full size Christmas tree, smaller tabletop Christmas trees are often desirable, particularly in a limited space environment. One conventional approach for implementing such a tabletop Christmas tree is to use old coat hangers. The coat hangers are bent into a frame that is used to support decorative material. However, such conventional coat hanger frames are often frustrating to assemble, provide inconsistent results, and/or are otherwise time consuming to assemble.

It would be desirable to implement a frame for an ornamental decoration.

### SUMMARY OF THE INVENTION

The present invention concerns an apparatus comprising a plurality of legs. Each of the legs may have a plurality of holders and a base. The base may comprise (i) a first connector on one side of the base and (ii) a second connector on another side of the base. Each of the plurality of legs may be configured to (i) connect to the second connector of one of the plurality of legs using the first connector, (ii) connect to the first connector of another of the plurality of legs using the second connector, (iii) be flexible about an axis and (iv) be arranged in a circular fashion. The holders may be configured to secure one or more lights of a strand of lights.

The objects, features and advantages of the present invention include providing a frame for an ornamental decoration that may (i) be implemented using a molding process, (ii) snap together, (iii) secure strands of lights and/or (iv) be easy to assemble.

### BRIEF DESCRIPTION OF THE DRAWINGS

These and other objects, features and advantages of the present invention will be apparent from the following detailed description and the appended claims and drawings in which:

FIG. 1 is an overall view of a frame in accordance with an embodiment of the invention;

FIG. 2 is a top view of the frame of FIG. 1;

FIG. 3 shows details of a top portion of the frame;

FIGS. 4(a)-4(d) show details of one of the legs of a frame;

FIG. 5 shows details of how a light string is attached to one of the legs;

FIG. 6 shows an alternate diagram with one or more partial legs;

FIG. 7 shows an alternate diagram for connecting a top portion of the legs;

FIG. 8 shows an alternate diagram for securing the bottom portion of the legs;

FIG. 9 shows a cross section of the alternate connection of the bottom portion of the leg shown in FIG. 8;

FIGS. 10(a)-10(b) show details of a slidable bulb holder;

FIGS. 11(a)-11(b) show additional details of a slidable bulb holder;

FIG. 12 shows a diagram of the overall frame with the slidable bulb holders;

FIG. 13 shows an embodiment with eight legs;

FIG. 14 shows a top view of the embodiment of FIG. 13;

FIG. 15 shows an embodiment with ten legs; and

FIG. 16 shows a top view of the embodiment of FIG. 15;

FIG. 17 shows an alternate implementation of a leg;

FIG. 18 shows details of a top section of the alternate leg of FIG. 17;

FIG. 19 shows details of a bottom portion of the leg of FIG. 17;

FIG. 20 shows a bottom view of the leg of FIG. 17 in an uncompressed state;

FIG. 21 shows another bottom view of the leg of FIG. 17 in a compressed state;

FIG. 22 shows a number of the legs of the embodiment of FIG. 17;

FIG. 23 shows a number of the legs of the embodiment of FIG. 17;

FIG. 24 shows an overall view of a plurality of the alternate legs connected; and

FIG. 25 shows a top view of a plurality of the alternate legs of FIG. 17 connected.

### DETAILED DESCRIPTION OF THE PREFERRED EMBODIMENTS

Embodiments of the invention include implementing a frame for an ornamental decoration. The frame may hold (or support) garland, or other ornamental materials. The frame may be made using a molding process to form individual pieces (or legs) that may be snapped together quickly and easily. The ornamental design may be a Christmas tree, a flower arrangement, or other decorative type arrangement. In one example, the tree may be around 18 inches high, suitable to be used as a desktop (or tabletop) decoration and/or a decoration stored in a shelving unit or wall unit. The tree may hold strings of lights, such as LED lights, or conventional incandescent lights. Portions of the frames may be snapped together to provide easy assembly.

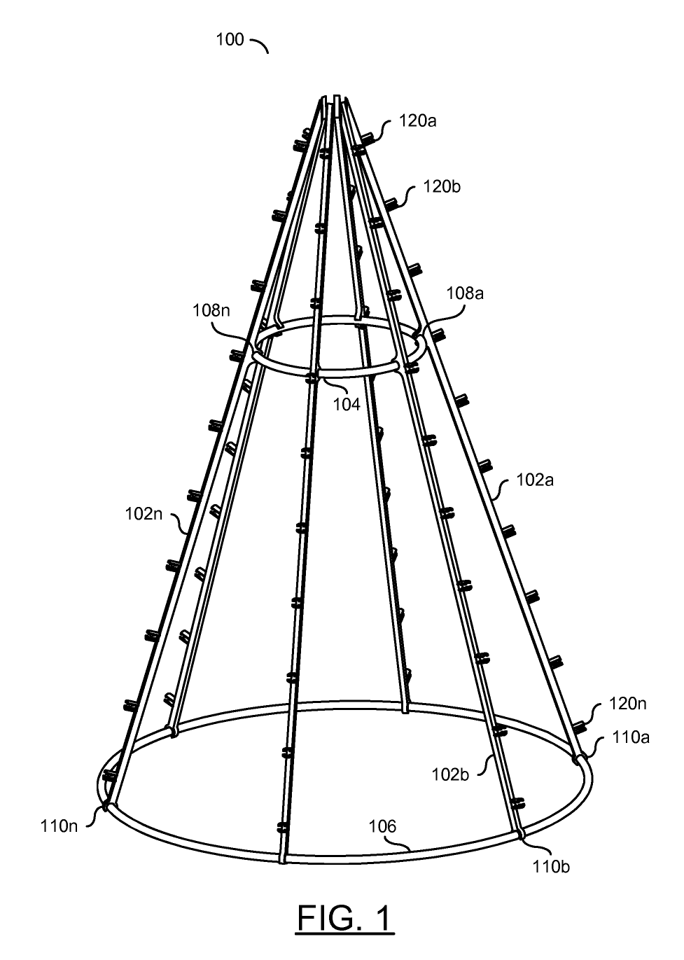

Referring to FIG. 1, an overall diagram of an apparatus 100 is shown in accordance with an embodiment of the invention. The apparatus 100 may be a Christmas tree, or other decorative arrangement. The apparatus 100 generally comprises a plurality of legs 102a-102n, a support portion (or connection portion) 104 and a support portion (or connection portion) 106. Each of the legs may have a first attachment portion 108 and a second attachment portion 110. In one example, the leg 102a may have a first attachment portion 108a and a second attachment portion 110a. The first attachment portion may be configured to clip onto the support portion 104. The second attachment portion 110a may be configured to clip onto the support portion 106. Alternate forms of the connection may be shown in the various figures. A number of holders 120a-120n are shown on the leg 102a. The holders may be configured to hold a strand of lights and/or other decorations (e.g., garland, ornaments, etc.). For example, the holder 120a may hold a first bulb of a strand of lights. The holder 120b may be configured to hold a second bulb of a plurality of lights.

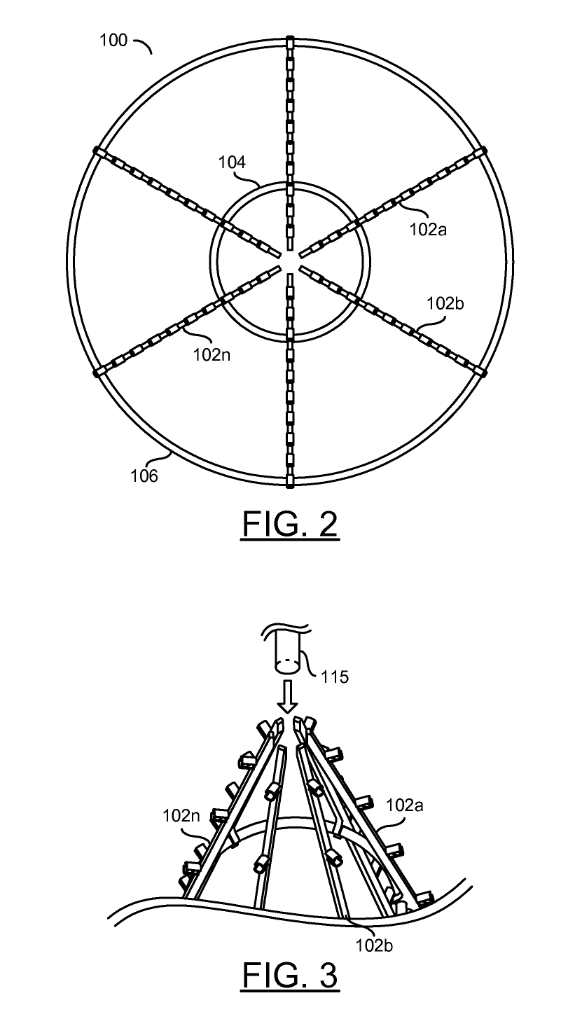

Referring to FIG. 2, a top view of the apparatus 100 is shown. The support portion 104 is shown as an inner circle that is connected to each of the legs 102a-102n (e.g., attached to the attachment portions 108a-108n). The support portion 106 is shown as an outer circle that is also connected to each of the legs 102a-102n (e.g., attached to the attachment portions 110a-110n). More support portions may be implemented based on a size of the apparatus 100 (e.g., to provide greater stability and/or structural integrity). For example, more support portions may prevent the legs 102a-102n from sliding side-to-side. Generally, additional support portions may be implemented as circular portions having sizes (e.g., a radius) in between the size of the inner support portion 104 and the outer support portion 106. For example, the inner support portion 104, the outer support portion 106 and/or any additional support portions may be arranged in a concentric fashion. The support portion 104 and/or 106 may be multi-sided. The legs 102a-102n may accommodate additional support portions by implementing a corresponding amount of additional attachment portions. The number of support portions and/or attachment portions may be varied according to the design criteria of a particular implementation.

Referring to FIG. 3, a view of a top portion of the apparatus 100 is shown. The top portion may be configured to hold or mount an ornament 115. The ornament 115 may be implemented as a star or an angel. The legs 102a-102n may lean inward towards the top of the apparatus 100. For example, the legs 102a-102n may meet (e.g., touch and/or connect) at the top of the apparatus 100. When the legs 102a-102n meet at the top of the apparatus 100, space may not be available for the ornament 115. In another example, the legs 102a-102n may approach (but not touch) at the top of the apparatus 100, leaving a space. The space may be available to insert the ornament 115. In some embodiments, the tops of the legs 102a-102n may provide support (e.g., a small platform) to hold the ornament 115.

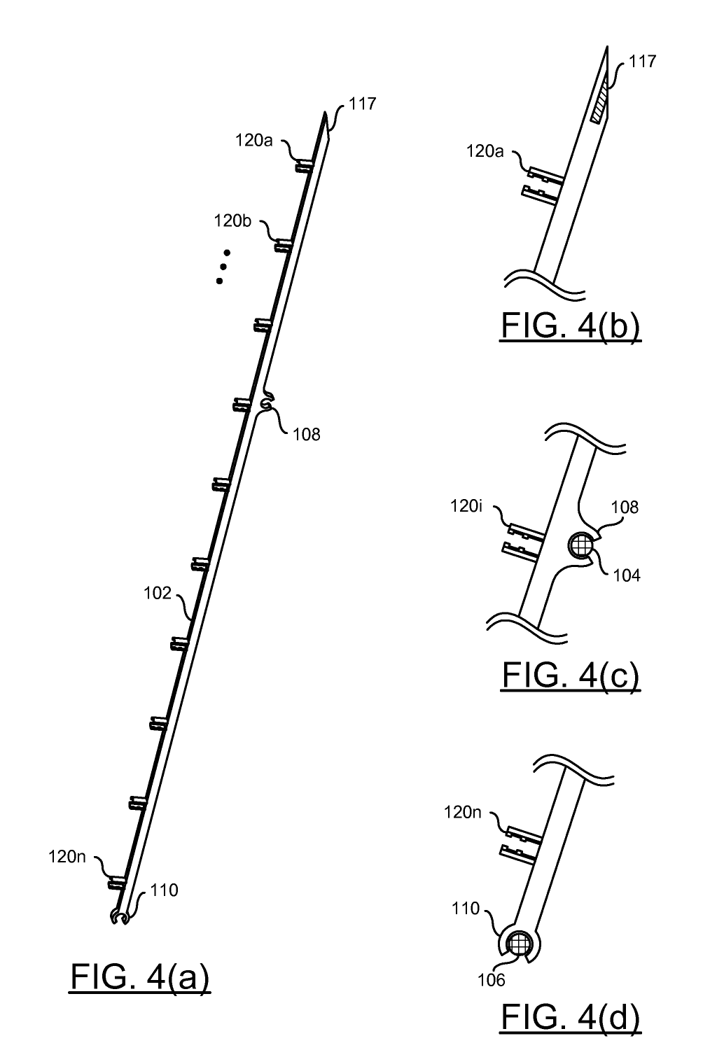

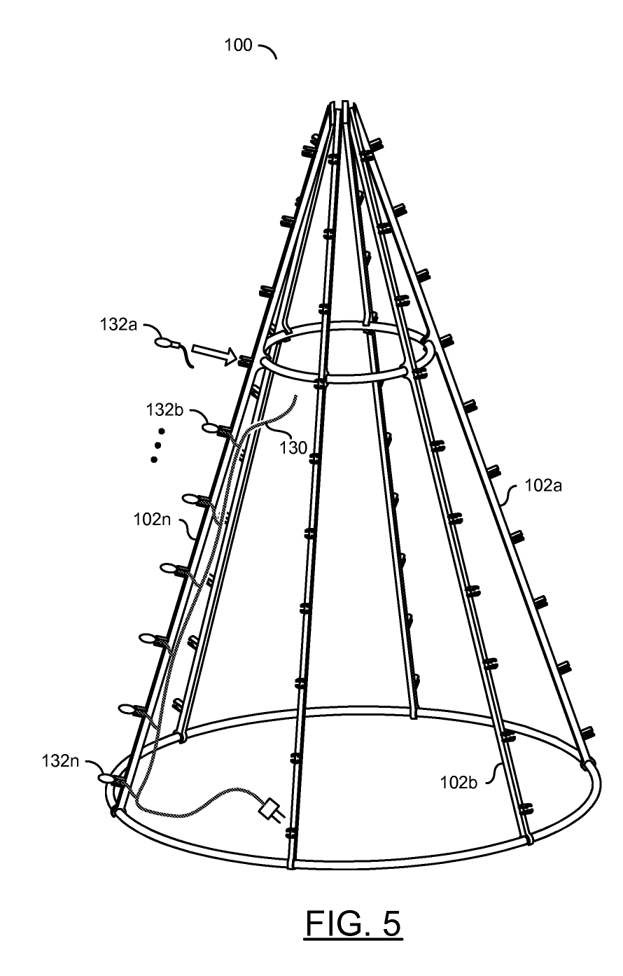

Referring to FIGS. 4(a)-4(d), a diagram of one of the legs is shown. The legs 102a-102n may be angled on the inside to fit the top portion of the legs 102a-102n at the top of the apparatus 100. A narrow and/or angled inside portion 117 of the leg 102 may implement a hole to provide support for mounting an angel or a star (e.g., the ornament 115). Details of the inside portion 117 are shown in FIG. 4(b). The open sides of the holders 120a-120n are shown configured to hold a wire, or a mini LED (to be described in more detail in connection with FIG. 5). In one example, the string of lights may be 50 to 100 lights. The lights may be held out and away from the legs 102a-102n and/or the support portions 104 and/or 106. In one example, the apparatus may hold 45-60 feet of colored garlands, decorative materials, etc.

The middle of the leg 102 (e.g., the attachment portion 108) may be molded to clip and/or insert into the support portion 104. In some embodiments, the connection 108 may be a slip fit (e.g., as shown in FIG. 4(c)). In some embodiments, the connection 108 may be inserted into the support portion 104. The bottom of the leg 102 (e.g., the attachment portion 110) may be molded to clip and/or insert into the support portion 106. In some embodiments, the connection 110 may be a slip fit (e.g., as shown in FIG. 4(d)). In some embodiments, the connection 110 may be inserted into the support portion 106.

Referring to FIG. 5, a diagram illustrating the attachment of a string of lights 130 is shown. A number of lights 132a-132n are shown connected to the string of lights 130. Each of the lights 132a-132n may be implemented as a small incandescent bulb, an LED bulb, or other type of light. The lights 132a-132n may be removably inserted into the holders 120a-120n. In some embodiments, the holders 120a-120n may be implemented to fit only a particular type of ends of the lights 132a-132n (e.g., the lights 132a-132n and the apparatus 100 may be sold as a single product). In some embodiments, the holders 120a-120n may be implemented to fit a variety of ends of the lights 132a-132n (e.g., the holders 120a-120n may be universal). An order of insertion and/or an arrangement of the lights 132a-132n may be varied according to the design criteria of a particular implementation. Generally, any order of insertion and/or arrangement of the lights 132a-132n may be selected. In some embodiments, the holders 120a-120n may have indicators (e.g., be color-coded) to allow for particular designs and/or arrangements of the lights 132a-132n.

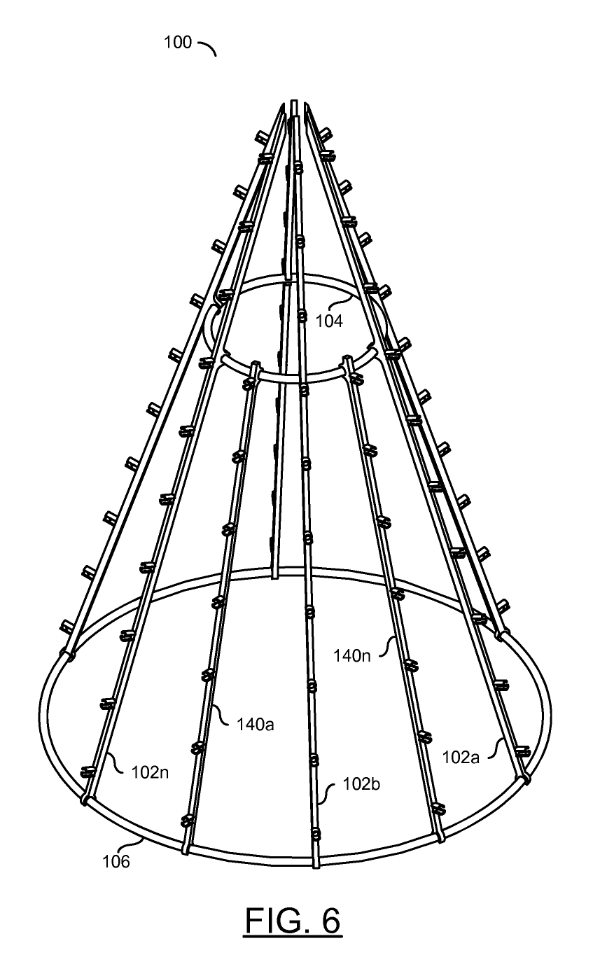

Referring to FIG. 6, a diagram illustrating a number of partial legs 140a-140n is shown. The partial legs 140a-140n are shown connected in an alternating pattern with the legs 102a-102n. The legs 102a-102n are shown implemented longer than the partial legs 140a-140n. The partial legs 140a-140n generally connect between the securing portion 104 and the securing portion 106. The partial legs 140a-140n may be shorter than the legs 102a-102n. Since the point (e.g., the top) of the cone formed by the apparatus 100 is denser than the bottom of the cone, fewer of the partial legs 140a-140n may be needed. Implementing the partial legs 140a-140n may reduce a cost of manufacturing the apparatus 100. Implementing the partial legs 140a-140n may allow for larger ornaments at the top of the apparatus 100 (e.g., by reducing crowding of the ornaments).

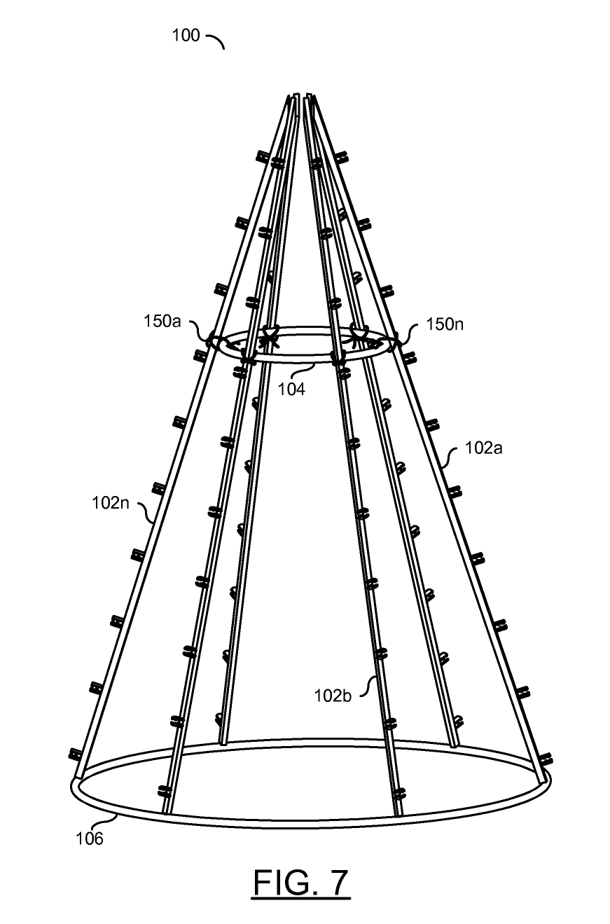

Referring to FIG. 7, a diagram of an alternate top attachment portion for the apparatus 100 is shown. A number of ties 150a-150n are shown. The ties 150a-150n are shown connecting the legs 102a-102n to the securing portion 104. In some embodiments, the ties 150a-150n may be implemented instead of the attachment portions 108a-108n. In some embodiments, the ties 150a-150n may be implemented in addition to the attachment portions 108a-108n. In one example, the ties 150a-150n may be implemented as twist ties. In another example, the ties 150a-150n may be implemented as bendable wires. The ties 150a-150n may be colored. For example, the ties 150a-150n may be colored to conceal the twist ties 150a-150n when viewing the apparatus 100. In another example, the ties 150a-150n may be colored (e.g., with festive colors) to provide an additional decorative effect. The implementation of the twist ties 150a-150n may be varied according to the design criteria of a particular implementation.

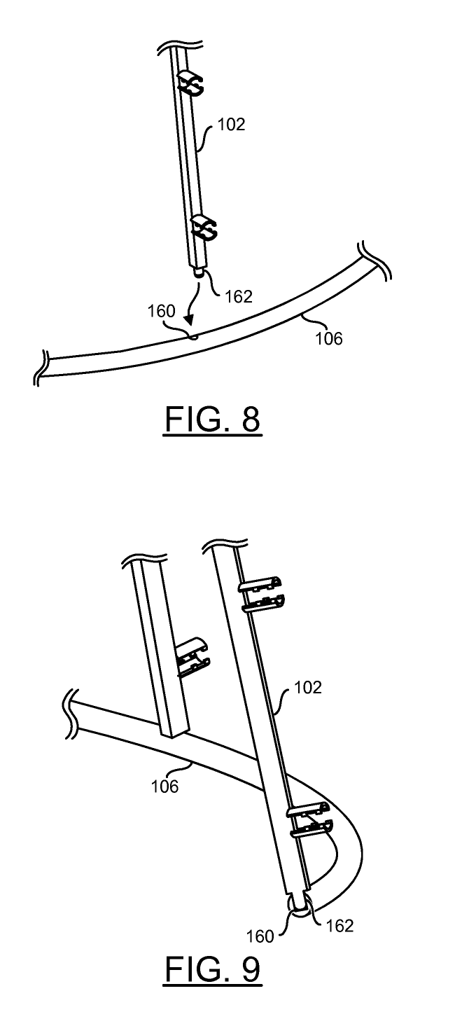

Referring to FIG. 8, a diagram of an alternate bottom securing portion 106 is shown. The securing portion 106 is shown having a hole 160. The hole 160 may accept a protrusion 162 that may be implemented on the bottom of the leg 102. The hole 160 is shown configured to slide on the protrusion 162 of the leg 102. In some embodiments, the protrusion 162 may be threaded to allow the leg 102 to be screwed into the hole 160 of the securing portion 106. In some embodiments, the protrusion 162 may be configured to snap into the hole 160. The implementation and/or shape of the hole 160 and/or the protrusion 162 may be varied according to the design criteria of a particular implementation.

Referring to FIG. 9, a diagram of a side view of the securing portion 106 of FIG. 8 is shown. A cross-section of the securing portion 106 is shown. The hole 160 is shown having a generally square outline. The protrusion 162 is shown having a slightly rounded outline. However, the particular shape of the outline of the hole 160 and/or the protrusion 162 may be varied depending on the design criteria of a particular implementation. Screwing and/or snapping the protrusion 162 into the hole 160 may improve the structural integrity of the apparatus 100.

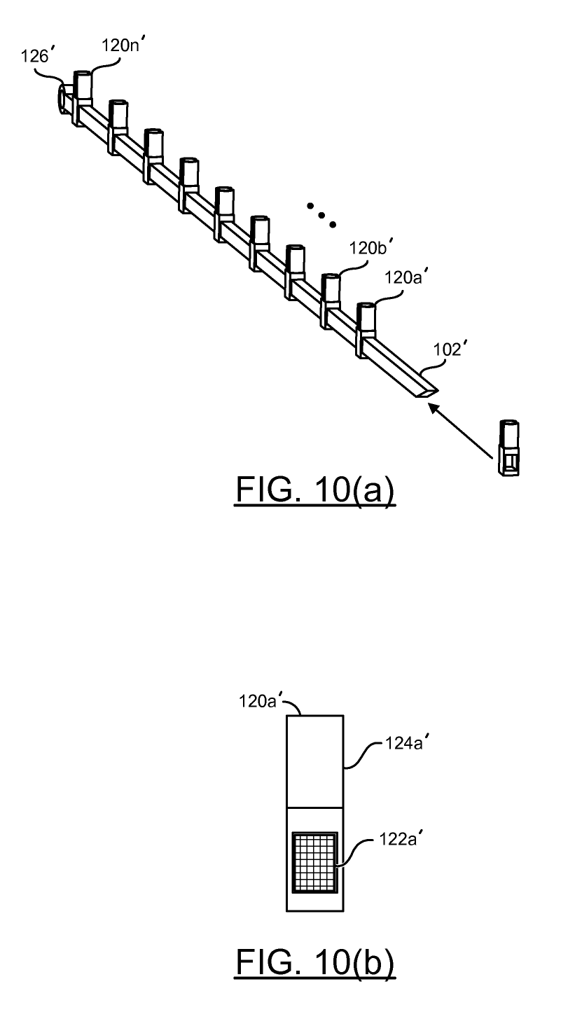

Referring to FIG. 10(a) and FIG. 10(b), a diagram of an alternate leg 102′ with a slidable bulb attachment portion 120′ is shown. Referring to FIG. 10(a), the alternate leg 102′ is shown having a number of slidable bulb attachment portions 120a′-120n′. The slidable bulb attachment portions 120a′-120n′ may be free to slide about the alternate leg 102′. FIG. 10(b) shows a cross-section of one of the slidable bulb attachment portions 120a′.

The slidable bulb attachment portions 120a′-120n′ may be configured to have an opening 122a′ and a holder portion 124a′. FIG. 10(b) shows the slidable portion 120a′ having the opening 122a′ and the holder portion 124a′. The holder portion 124a′ may hold one of the lights 132a-132n. The opening 122a′ may be configured to slide over the alternate leg 102′. For example, the opening 122a′ may slide up and down the length of the alternate leg 102′. The alternate leg 102a′ may be implemented with a stopper 126′. The stopper 126′ may prevent the slidable bulb attachment portions 120a′-120n′ from sliding off the alternate leg 102′. The stopper 126′ may be implemented on each end of the alternate leg 102′.

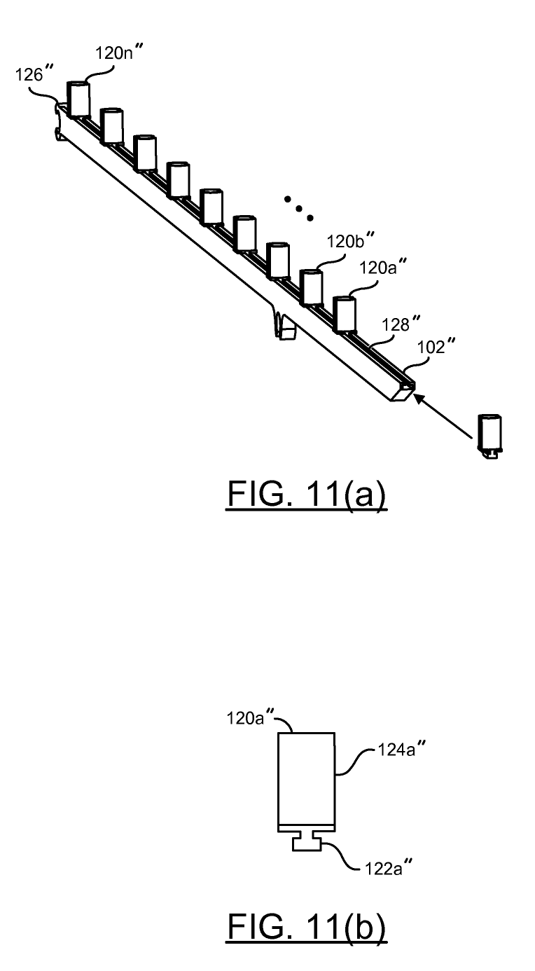

Referring to FIG. 11(a) and FIG. 11(b), a diagram of an alternate slidable bulb attachment portion 120a″ is shown. Referring to FIG. 11(a), an alternate leg 102″ is shown having a number of slidable bulb attachment portions 120a″-120n″. The slidable bulb attachment portions 120a″-120n″ may be configured to slide along a track 128″ in the alternate leg 102″. The alternate leg 102″ may implement a stopper 126″. The stopper 126″ may be configured to prevent the slidable bulb attachment portions 120a″-120n″ from sliding out of the track 128″. The stopper 126″ may be removable to allow the slidable bulb attachment portions 120a″-120n″ to be replaced.

Referring to FIG. 11(b), a cross section of one of the slidable bulb attachment portions 120a″ is shown. The slidable bulb attachment portion 120a″ is shown having a notch 122a″ and a holder 124a″. The notch 122a″ may be configured to secure the slidable bulb attachment portion 120a″ in the track 128″, while allowing the slidable bulb attachment portion 120a″ to slide along the track 128″. Generally, the shape of the notch 122a″ may correspond the shape of the track 128″. The shape of the notch 122a″ and/or the track 128″ may be varied according to the design criteria of a particular implementation. The holder 124a″ may be configured to hold one of the lights 132a-132n.

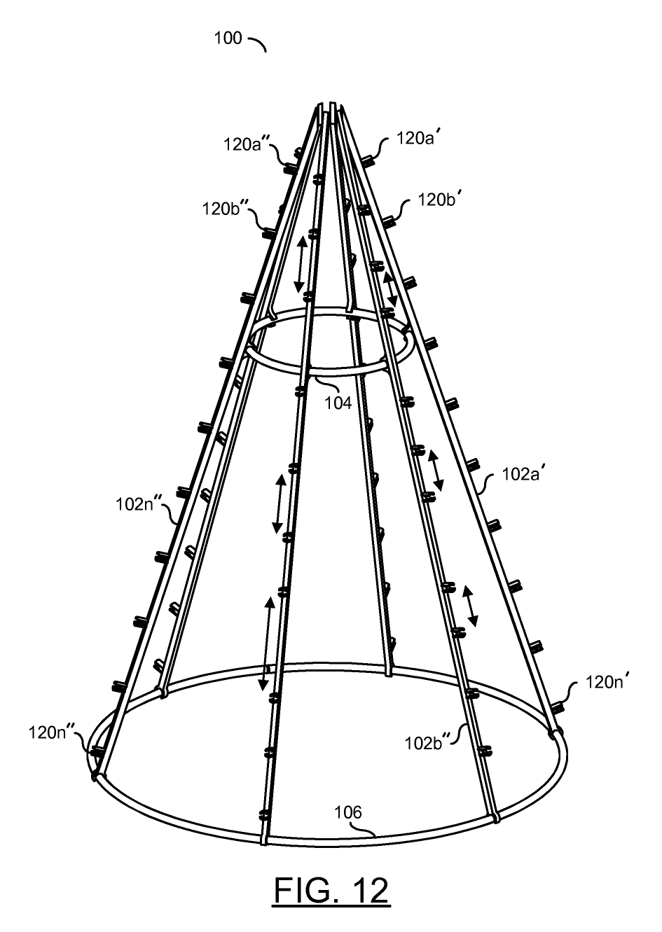

Referring to FIG. 12, a diagram of the apparatus 100 showing the slidable bulbs is shown. The apparatus 100 shown in FIG. 12 may implement either slidable bulb attachment portions 120a′-120n′ and/or the slidable bulb attachment portions 120a″-120n″. The particular position of each of the slidable bulb attachment portions 120W-120n′ (or 120a″-120n″) may move up and down each of the alternate legs 102a′-102n′ (or 102a″-102n″). The spacing between the slidable bulb attachment portions 120a′-120n′ (or 120a″-120n″) may be varied to allow for a variety of decorative designs.

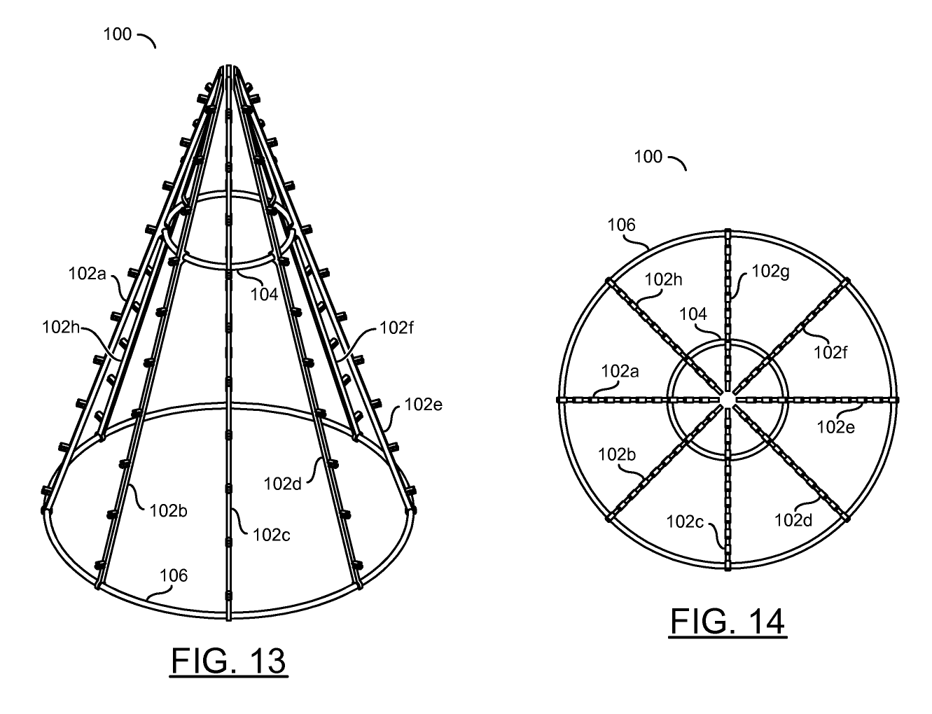

Referring to FIG. 13, an overall diagram of an embodiment of the apparatus 100 with eight legs is shown. The apparatus 100 is shown in a generally perspective view. The eight legs 102a-102h are shown spaced evenly around the apparatus 100.

Referring to FIG. 14, a top view of the embodiment of FIG. 13 is shown. The apparatus 100 is shown from a generally overhead view. The example of the apparatus 100 shown in FIG. 14 shows an implementation with the eight legs 102a-102h. The top view shows the eight legs 102a-102h evenly spaced about the support portion 104 and the support portion 106. Each of the legs 102a-102h are shown leaning inward from the support portion 106. Each of the legs 102a-102h generally approach (e.g., come close to) but do not touch the other legs 102a-102h. In some embodiments, the legs 102a-102h may touch at the top of the apparatus 100.

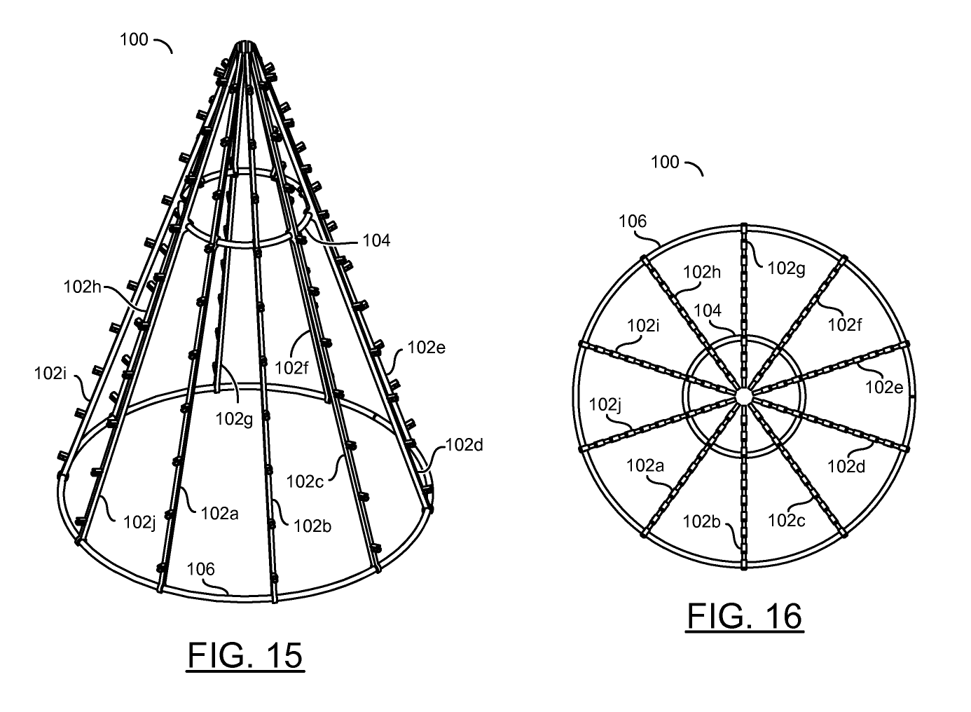

Referring to FIG. 15, an overall diagram of an embodiment of the apparatus 100 with ten legs is shown. The apparatus 100 is shown in a generally perspective view. The ten legs 102a-102j are shown spaced evenly around the apparatus 100. Using the ten legs 102a-102j may allow for more support for the apparatus 100 and/or provide more options for decorating the apparatus 100.

Referring to FIG. 16, a top view of the embodiment of FIG. 15 is shown. The apparatus 100 is shown from a generally overhead view. The example of the apparatus 100 shown in FIG. 16 shows an implementation with the ten legs 102a-102j. The top view shows the ten legs 102a-102j evenly spaced about the support portion 104 and the support portion 106. Each of the legs 102a-102j are shown leaning inward from the support portion 106. Each of the legs 102a-102j generally approach (e.g., come close to) but do not touch the other legs 102a-102j. In some embodiments, the legs 102a-102j may touch at the top of the apparatus 100.

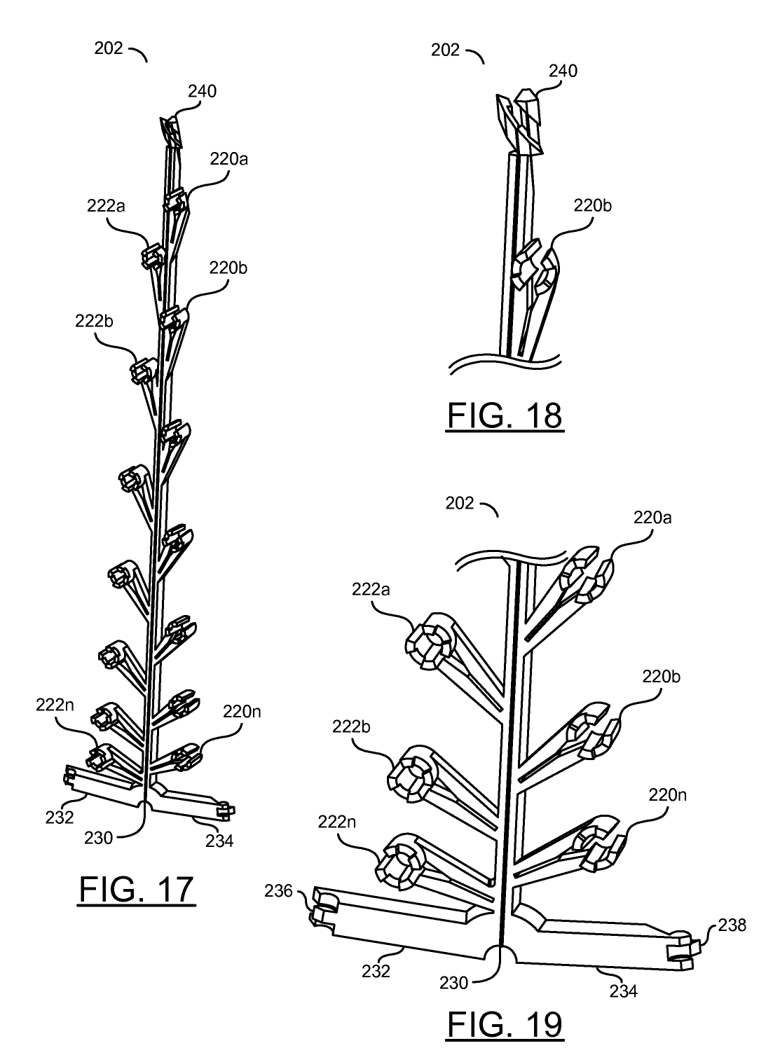

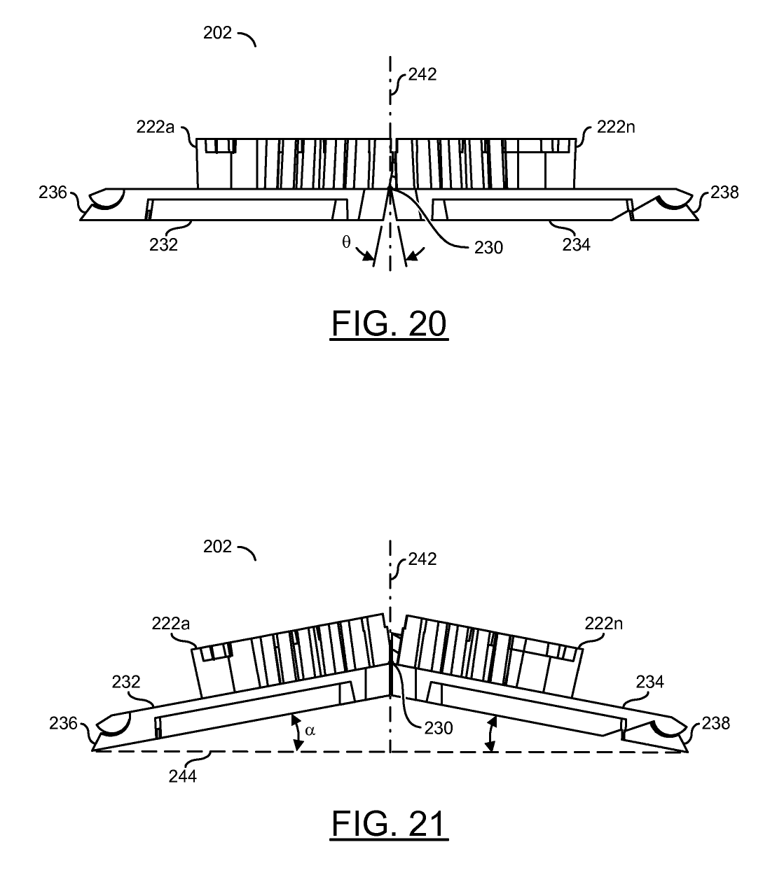

Referring to FIG. 17, a diagram of an alternate leg 202 is shown. A number of holder portions 220a-220n are shown on one side of the leg 202. A number of holder portions 222a-222n are shown on another side of the leg 202. A line (or axis) 230 shows a connection between a left side base 232 and a right side base 234. The line (or axis) 230 may allow the left side base 232 to flex with respect to the right side base 234 (e.g., the leg 202 may be flexible about the axis 230). The flex will be described in more detail in connection with FIGS. 20 and 21. The leg 202 is shown having a top portion 240. The top portion will be described in more detail in connection with FIGS. 18, 24 and 25. The holders 220a-220n are shown evenly spaced between the holders 222a-222n and on an opposite side of the leg 202. The holders 222a-222n are shown evenly spaced between the holders 220a-220n and on an opposite side of the leg 202. While the example shown illustrates an even spacing, the particular arrangement of the holders 220a-220n and/or the holders 222a-222n may be varied according to the design criteria of a particular implementation.

Referring to FIG. 18, details of a top section of the alternate leg of FIG. 17 is shown. The holder 220b is shown in more detail. The holder 220b may be configured to securely clip on to a light (not shown), garland (not shown), or other portions of a decorative arrangement. The top portion 240 is shown at the top end of the leg 202. The top portion 240 is shown as a part of a cylinder shape. For example, when the legs 202a-202n are arranged together, the top portions 240a-240n may form a complete cylinder shape. The type of shape of the top portion 240 may be varied according to the design criteria of a particular implementation. The top portion 240 is shown having a notch (or track). The notch may allow an ornament and/or a clasp device (e.g., a clip) to attach to the top portion 240.

Referring to FIG. 19, details of a bottom portion of the leg of FIG. 17 is shown. A number of holders (or connectors) 220a-220n and 222a-222n are shown. The holders 220a-220n may be configured to hold one or more lights of a strand of lights (or other type of decoration). The left side base 232 and the right side base 234 (together providing a base for the leg 202) may have a length that is varied according to the design criteria of a particular implementation. For example, a base with a larger width may provide more stability for the leg 202. The left side base 232 is shown including a connector (or attachment portion) 236. The right side base 234 is shown including a connector (or attachment portion) 238. The connector 236 may be configured to connect (e.g., clip, secure, clasp, etc.) into the connector 238 of another one of the legs 202a-202n. Similarly, the connector 238 may be configured to connect (e.g., clip, secure, clasp, etc.) into the connector 236 of another one of the legs 202a-202n.

In the example shown, the connector 236 is shown having three prongs (e.g., two prongs on an inside surface of the leg 202 and one prong on the outside surface of the leg 202) and the connector 238 is shown having three prongs in an opposite configuration (e.g., two prongs on the outside surface of the leg 202 and one prong on the inside surface of the leg 202). The opposite configuration of the connectors 236 and 238 may allow the legs 202a-202n to form a secure lock. The shape and/or locking/securing mechanism of the connectors 236 and/or 238 may be varied according to the design criteria of a particular implementation.

Referring to FIG. 20, a bottom view of the leg 202 of FIG. 17 is shown. The bottom view may show the left side base 232 and the right side base 234. The line 230 is shown in an unflexed state (e.g., the leg 202 may be uncompressed). An axis 242 is shown between the left side base 232 and the right side base 234. An angle θ is shown between the left side base 232 and the right side base 234. In the example shown in FIG. 20, the leg 202 is in a generally uncompressed state, where the angle θ is shown in an open position (e.g., the angle θ is a non-zero value). Generally, the leg 202 may be in an unflexed (or uncompressed) state when the apparatus 100 is not assembled. For example, the unflexed state may allow each of the legs 202a-202n to be stored (or stacked) flat (e.g., reducing an amount of storage space for the apparatus 100).

The leg 202 may be flexed along the line 230. For example, the leg 202 may be flexed by pressing the left side base 232 and the right side base 234 in a generally downward direction, while the line 230 is either pressed in a generally upward direction (or is not moved). As the leg 202 is flexed, the angle θ may be reduced. A fully flexed (or compressed state) may reduce the angle θ to a value of zero. Flexing the leg 202 along the line 230 may increase an angle α (to be described in more detail in FIG. 21). When the leg 202 is unflexed (e.g., in a fully uncompressed state), the angle θ may be at a maximum value.

Referring to FIG. 21, another bottom view of the leg 202 of FIG. 17 is shown. The bottom view may show the left side base 232 and the right side base 234. The line 230 is shown in a flexed state (e.g., the leg 202 may be compressed). The axis 242 is shown between the left side base 232 and the right side base 234. The angle α is shown with respect to a generally horizontal surface 244 (e.g., in the uncompressed state shown in FIG. 20, the left side base 232 and the right side base 234 may rest on the horizontal surface 244). The leg 202 is shown in a generally flexed (or compressed) state. In the compressed state, the angle θ is essentially zero. In the compressed state, the angle α may be a non-zero value. In some embodiments, the angle α may be the same value in the compressed state as the angle θ in the uncompressed state. In some embodiments, the angle α in the compressed state may be different than the angle θ in the uncompressed state. The value of the angle θ and/or the angle α may be varied according to the design criteria of a particular implementation.

The pressure created when the legs 202a-202n are flexed may allow the apparatus to be held together without glue (or other type of adhesive). For example, the outward pressure created by the legs 202a-202n when flexed creates a locking effect (e.g., a secure lock). The locking effect may allow the apparatus 100 to be freestanding without external clips and/or external connectors. For example, the outward pressure created by the legs 202a-202n when flexed may improve a structural integrity of the frame 250. Generally, the leg 202 may be in a flexed (or compressed) state when the apparatus 100 is assembled.

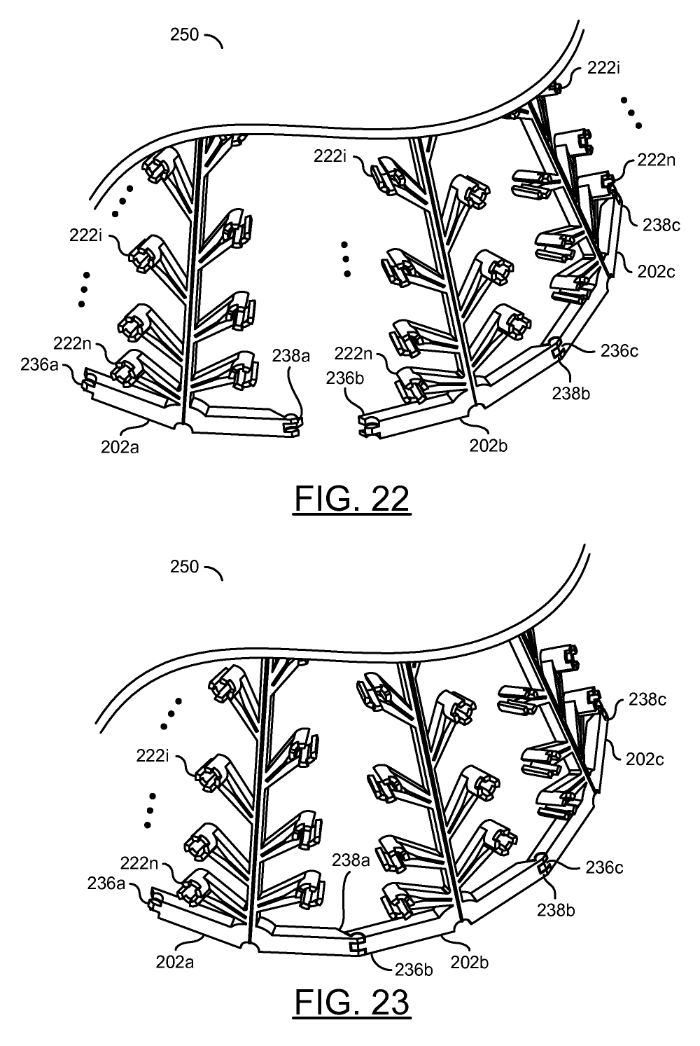

Referring to FIG. 22, a number of the legs 202a-202c of the embodiment of FIG. 17 are shown. The legs 202a-202c may be assembled to form a frame 250 (e.g., an assembled frame). The leg 202a is shown having a connector portion 236a (e.g., a left connector) and a connector portion 238a (e.g., a right connector). The frame 202b is shown having a connector portion 236b (e.g., a left connector). The connector portion 238a generally interlocks with the connector portion 236b (e.g., the right connector of the leg 202a connects to the left connector of the leg 202b). For example, the connector portion 236b is shown interlocked with the connector portion 236c. The legs 202a-202c are shown in a generally flexed state as the legs 202a-202c are interlocked.

Referring to FIG. 23, a number of the legs 202a-202c of the embodiment of FIG. 17 are shown. The frame 250 is shown having each of the legs 202a-202c interconnected. For example, the right connector 238a of the leg 202a is interlocked with the left connector 236b of the leg 202b and the right connector 238b of the leg 202b is interlocked with the left connector 236c of the leg 202c. For example, the connectors 236a-236n and/or the connectors 238a-238n may form a secure lock when the legs 202a-202n are in a flexed state. When each of the legs 202a-202n are interconnected (or interlocked) the frame 250 may be in a fully assembled state (e.g., freestanding).

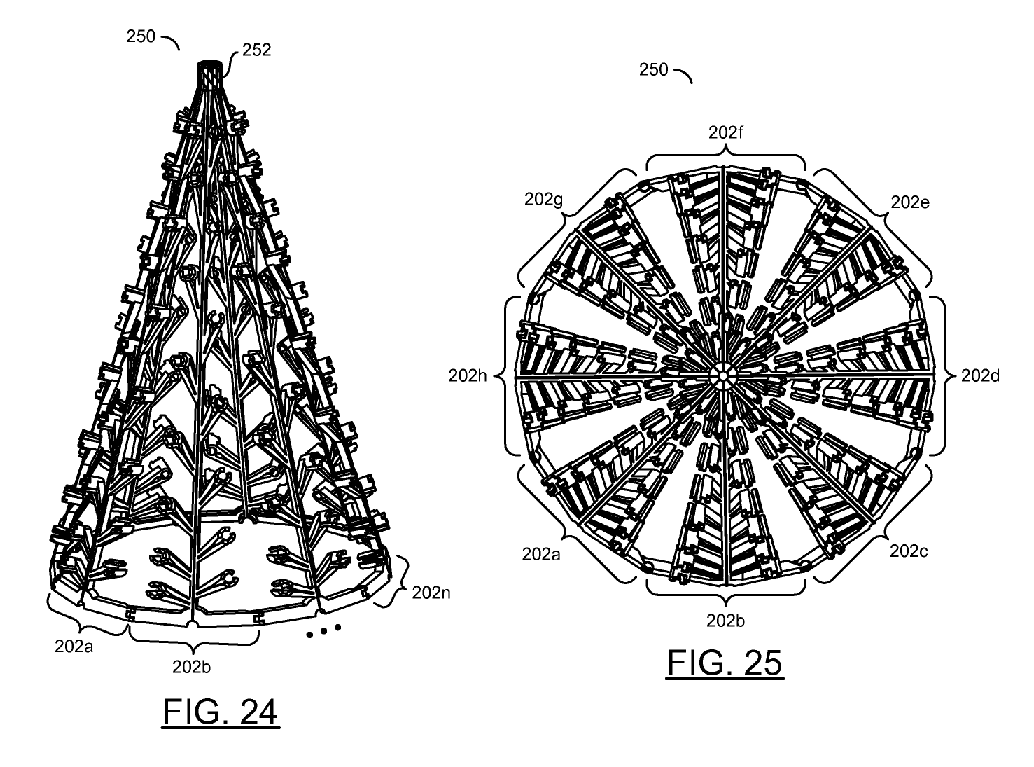

Referring to FIG. 24, an overall view of a plurality of the alternate legs 202a-202n of the embodiment in FIG. 17 is shown. The frame 250 is shown in a generally completed state. For example, each of the legs 202a-202n may be in a flexed (or compressed) state. The flexed state of the legs 202a-202n may allow the assembled frame 250 to be freestanding. The legs 202a-202n are shown leaning inward to meet at a top of the frame 250. An ornament 252 is shown on top of the assembled frame 250. For example, the ornament 252 may be configured to fit over the top portions 240a-240n of the legs 202a-202n (e.g., the ornament 252 may connect each of the legs 202a-202n together). In another example, the ornament 252 may slide and lock into the notches of the top portions 240a-240n.

In some embodiments, the ornament 252 may be used as a clasping device (or clip) to hold the legs 202a-202n together (e.g., to maintain a conical shape of the assembled frame 250). In some embodiments, the ornament 252 may rest on the legs 202a-202n for a decorative effect. In some embodiments, each of the top portions 240a-240n of the legs 202a-202n may extend towards the top portions 240a-240n of each of the legs 202a-202n (e.g., forming a point of the frame 250). For example, the top portions 240a-240n may approach, but not touch the other top portions 240a-240n (e.g., leaving a space at the top of the frame 250). The ornament 252 may be configured to fit (e.g., be secured) within the space at the top of the frame 250. The implementation of the ornament 252 and/or the top portions 202a-202n may be varied according to the design criteria of a particular implementation.

Referring to FIG. 25, a top view of a plurality of the legs 202a-202h of FIG. 17 is shown. A top view of the assembled frame 250 is shown. The top view of the assembled frame 250 shows the legs 202a-202h arranged in a circular fashion. The example shown in FIG. 25 implements 8 of the legs 202a-202h to form the assembled frame 250. The number of legs 202a-202n of the assembled frame 250 may be varied according to the design criteria of a particular implementation. For example, using more of the legs 202a-202n may allow the assembled frame 250 to be larger (e.g., have a base with a larger radius).

Each of the portions of the apparatus 100 and/or the frame 250 (e.g., the legs 102a-102n, the inner support portion 104, the outer support portion 106, the legs 202a-202n, the holders 220a-220n, the holders 222a-222n) may be implemented using materials according to the design criteria of a particular implementation. For example, the material may be a plastic material. The plastic material may be through a molding process (e.g., injection molding).

While the invention has been particularly shown and described with reference to the preferred embodiments thereof, it will be understood by those skilled in the art that various changes in form and details may be made without departing from the scope of the invention.

1. An apparatus comprising:
a plurality of legs each having a plurality of holders and a base, wherein (A) said base comprises (i) a first connector on one side of said base and (ii) a second connector on another side of said base, (B) each of said plurality of legs is configured to (i) connect to said second connector of one of said plurality of legs using said first connector, (ii) connect to said first connector of another of said plurality of legs using said second connector, (iii) be flexible about an axis and (iv) be arranged in a circular fashion and (C) said holders are configured to secure one or more lights of a strand of lights.

2. The apparatus according to claim 1, wherein outward pressure from flexing said plurality of legs about said axis creates a secure lock.

3. The apparatus according to claim 1, wherein outward pressure from flexing said plurality of legs about said axis increases structural integrity.

4. The apparatus according to claim 1, wherein each of said plurality of legs further comprises a top portion configured to be connected to each of said plurality of legs using a clasping device.

5. The apparatus according to claim 4, wherein said clasping device is an ornament placed on top of said apparatus.

6. The apparatus according to claim 1, wherein each of said plurality of legs further comprises a top portion configured to extend towards each of said plurality of legs leaving a space at a top of said apparatus.

7. The apparatus according to claim 6, wherein an ornament is configured to be secured in said space at said top of said apparatus.

8. An apparatus comprising:
a plurality of legs each having a plurality of holders;
a first connection portion; and
a second connection portion, wherein (A) each of said plurality of legs is configured to (i) attach to said first connection portion and said connection portion, (ii) be arranged in a concentric fashion around said first and second connection portion, and (iii) be removably attached to said first and second connection portions and (B) said holders are configured to secure one or more lights of a strand of lights.

9. The apparatus according to claim 8, wherein said plurality of legs, said first connection portion and said second connection portion are made from plastic through a molding process.

10. The apparatus according to claim 8, wherein said first connection portion and said second connection portion are generally circular.

11. The apparatus according to claim 8, wherein said first connection portion and said second connection portion are hexagonal.

12. The apparatus according to claim 8, wherein said first connection portion and said second connection portion are oxagonal.

13. The apparatus according to claim 8, wherein said first connection portion and said second connection portion are multi-sided.

14. The apparatus according to claim 8, wherein said holders are configured to hold a string of lights.

15. The apparatus according to claim 8, wherein said holders are molded into said legs, where each holder is configured to secure one of said lights.

16. The apparatus according to claim 8, wherein said plurality of holders are implemented on a track and configured to slide along a length of each of said plurality of said legs.

17. The apparatus according to claim 8, wherein said first connection portion is configured to snap to each of said plurality of legs.

18. The apparatus according to claim 8, wherein the second connection portion is configured to be tied to each of said plurality of legs.
